(19) United States
(12) Patent Application Publication
(10) Pub. No.: US 2007/0239549 A1
(43) Pub. Date: Oct. 11, 2007

(54) SYSTEM AND METHOD FOR MONITORING ALCOHOLIC PRODUCTS

(76) Inventors: Michael LaFauci, Brooklyn, NY (US); George Mangione, Massapequa Park, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/671,617

(22) Filed: Feb. 6, 2007

Related U.S. Application Data
(60) Provisional application No. 60/771,137, filed on Feb. 7, 2006.

(51) Int. Cl. G06Q 50/00

(52) U.S. Cl. 705/15

(57) ABSTRACT

A tracking system for monitoring and controlling the alcoholic beverages that scans the information from a patron's ID, enters the information into a database, and continuously tallies the number of alcoholic beverages the patron bought at the venue within a specific period of time. The system cross-references the tally with the limit on the alcoholic beverages and denies the patron's request to buy the alcoholic beverages when the patron is over the limit. The system issues a warning to the user/server when the patron approaches the maximum limit. The system can also monitor various zones of a venue to determine if the patrons within any of the zones are drinking excessively. If they are, alcohol dispensing is stopped at the zone, or, alternatively, throughout the venue.

### RELATED APPLICATIONS

This application claims priority to U.S. provisional application Ser. No. 60/771,137, which was filed on Feb. 7, 2006 and incorporated herein by reference.

### BACKGROUND OF THE INVENTION

A. Field of Invention

This invention relates generally to a system and method for monitoring sales, purchases and/or distribution of products. More particularly, this invention involves a system and method for protecting the public by controlling the purchase of beverages and food products which may reduce cognitive capacity and self-control. Even more specifically, the invention relates to a system and method for tracking, recording and/or restricting the purchase and distribution of alcoholic beverages and other alcoholic products.

B. Description of the Prior Art

A number of systems for controlling sales of alcoholic beverages are known in the art. In one system, a patron's information is taken from an identification card, such as a driver's license, and is entered into the system. The patron's identifying information, which may include the driver's license number, name and age, is then printed on a wristband that is given to and worn by the patron. When ordering an alcoholic beverage, the information on the wristband is read at the point of service for the purpose of making a determination of whether the sale of alcohol is appropriate and authorized.

Another system utilizes a card with information stored on the card (usually by means of a magnetic strip) that specifies a predetermined amount of alcoholic beverage(s) allowed for purchase. Variations of this system are also known to calculate and take into account the number of alcoholic drinks purchased in a given period of time. Further, a password may be required to use such cards in connection with the purchase of alcoholic beverages. On cruise ships, systems exist which use cards to determine age eligibility when purchasing alcoholic beverages. Other systems and methods employ video cameras, document readers or biometric readers in connection with making a determination in connection with the purchase of alcoholic beverages.

One major drawback of the aforementioned systems is that they are specifically designed to screen out and prevent minors from obtaining alcoholic beverages by screening a patron's age and identifying fake forms of identification, rather than to prevent potentially harmful, public intoxication of individuals who are legally permitted to consume alcoholic products (at least from an age perspective). Another major drawback from which these systems suffer is that they utilize proprietary patron identification methods (i.e., wristbands, magnetic cards etc.), and not universally-recognized and accepted, government-issued forms of identification. Such types of proprietary identification, including the bracelet and swipe card, may easily be exchanged between patrons. Further, such forms of identification may be falsified or altered by, for example, replicating a bar code on a bracelet or reprogramming a swipe card that incorporates a magnetic strip or other conventional form of memory.

### SUMMARY OF THE INVENTION

To further assist in the understanding of the present invention, some of the terms used in this application are defined below.

“ID” means and includes any document, card or other article that uniquely identifies an individual, including military IDs, government- or state-issued IDs (i.e., passports, driver's licenses etc.), credit cards, college IDs, state-issued ID's, or any other ID issued and/or monitored by a reliable entity or source, such as the federal, state or local government and institutions.

“Biometric scan” means and includes the act or result of measuring any physical characteristic, including fingerprints, retinas or irises of an eye(s), hand features, facial patterns and other characteristics that may be evaluated or measured; “biometric ID” shall mean any of the physical characteristics or measurements themselves. Biometric identification uses a set of intrinsic, typically immutable, physical characteristics attributable to only a single person, typically for the purpose of identifying that person with a high degree of certainty. The measurements of the physical characteristics are obtained when a person registers or scans in characteristics which are translated into a digital representation by appropriate software algorithms. When a person is later evaluated for the purpose of identification, another biometric scan is performed, the results of which are transferred into a digital representation, and this digital representation is compared to the baseline digital representation that was previously stored. The identification is usually displayed as a probability match.

“Venue” means and includes all public and private locations of entertainment and enjoyment, sporting events, locations for recreation where alcohol is supplied, including, but not limited to, stadiums, parks, theme parks, arenas, hotels, lounge areas such as at at airline terminals, cruise ships, bars, nightclubs, gentleman's clubs, dance clubs, casinos, private clubs, music halls, restaurants, theaters, reception halls, private rooms within a premises, entire or multiple floors within a premises, poolside at hotels/motels, ski slopes or any other location where alcohol is served.

“Patron” means and includes any person in attendance at a venue or at an event taking place at a venue, whether paying for alcoholic products or obtaining alcoholic products free of charge. References herein to a fan at a game, patron, guest, hotel guest, or any other individual patron shall be used interchangeably with the term “patron.”

“Server,” when referring to a person, means and includes a cashier, waiter or waitress, bar attendant or barmaid, or any other individual selling or serving alcoholic beverages.

Additional terms will be further defined herein, as needed.

In its broadest aspects, the present invention provides a system and method that reliably monitors, controls, tracks, tallies, records and/or otherwise restricts the purchase, sale and distribution of alcoholic products, including alcoholic beverages and non-beverage items. It should be understood that while the following discussion is focused primarily on alcoholic beverages, the present invention is also applicable to other products as well, such as non-alcoholic beverages. In a preferred embodiment, the invention accepts an ID, credit card and/or other identifier that is unique to an individual and which preferably cannot be easily copied or altered. The system stores information in a database, where the information relates to a tally of the number of alcoholic beverage purchases made by all the patrons within a venue. The system also has the capacity to tally the number of alcoholic purchases over a specified period of time for each individual patron and to cross-reference or compare the tally data with preset alcohol purchasing limits defined at or by a particular venue.

The tally of purchases made by a particular patron enables the system to determine whether a patron has reached a preset maximum allowable limit, at which time, a user of the system, such as a server, would be required to or at least have the choice of restricting further sale/distribution of alcoholic products to that patron or to warn that patron that alcohol sale/distribution may be terminated in the future.

In addition to tracking the number of units of alcoholic beverages sold to different patrons, the tally may also be used to determine the number of drinks sold by a particular server and the number of cups being dispensed. Using this data the system can detect if a server is manipulating the amount of drinks that is sold. For instance, a server at a stadium is given a dozen cups, each of which should contain ten ounces of beer, for a total of 120 ounces. The server can pour eight ounces of beer in each cup rather than ten, thus gaining 24 extra ounces. The server can then sell three additional eight-ounce cups of beer and keep the proceeds from these three cups. Prior art systems did not have the capability of monitoring this type of fraud.

Furthermore, if the server is delivering the alcoholic beverages without pre-orders, the server is preferably required to enter into the system the number of containers (i.e., cups, mugs) required and the corresponding number of drinks and the total volume of these drinks is monitored. Then, the server will pick up the containers with the drinks for delivery to the respective patrons located in the stands of a stadium or another location within a venue. The system ensures in this manner that the server cannot dispense less than the mandated liquid volume per container.

In a preferred embodiment, a patron presents an ID which is read. If the ID is accepted, the purchase can be completed as a cash transaction or with a credit/debit card. In addition, the system can permit the operator of the system or server to restrict patrons' alcohol purchases by monitoring the patron's current alcohol consumption. Moreover, the system may provide multiple levels of redundancy, for example by requiring a server to compare the ID with the credit/debit card. This approach can be used to verify the patron's age eligibility to buy alcoholic beverages and to avoid the exchange of IDs among patrons, regardless of whether the purchase is for credit or cash. In the context of a credit card or other identifier which may be freely exchanged between patrons, it is desirable to at least match basic information present on the ID and credit card, such as the name on a patron's driver's license with the name on the credit card (or information stored on both), to ensure that the credit card does not belong to a different patron. Moreover, the patron's fingerprint or other biometric scan may be used to verify that the patron is submitting a particular form of ID is indeed that person.

The ID is read using a known commercial ID scanner. The system can employ different means of dispensing both alcoholic and non-alcoholic beverages as well as many other products. These means may include stationary housings fully staffed with several servers, stationary kiosks with a limited number of servers, or with an automated dispensing device and little or no personnel, and roaming vendors carrying portable devices for controlling and tallying dispensed products. The patron can also use a touch screen interface which is mounted on a countertop or at the patron's individual seat, for instance at a sporting event. The touch screen interface would be equipped with a commercial scanner to accept the ID. All of these means are used for remotely tracking and controlling dispensing of alcohol. The venue employees or servers are the users of the system, and patrons themselves may be the users where purchases are made from a kiosk or portable device (i.e., can be carried by a person, not fixed to a single physical location etc.). Furthermore, a database of patrons may be used that receives information or accept updates from local, state and/or federal government agencies regarding past violations involving alcohol (i.e., DWI, DUI, and Disorderly Conduct). The database of the system can be updated by day-to-day users or operators of the system, including venue owners, employees, employers and servers, who can manually enter negative (or positive) information or notes with regard to individual patrons. Such notes may provide that a patron exhibited negative behavior(s) including “unruly behavior,” “disorderly conduct,” or the like. The venue's database of unruly patrons can be examined by the server, user or operator of the system at any time to check if a particular patron has previously exhibited negative behavior. All data may be optionally erased from the database at the end of an event or after a specified period of time, except for those patrons who exhibited negative and unacceptable behavior. Preferably, for “unruly” patrons, a note section may be provided, permanently maintained or kept intact for a longer period of time, which contains all notes entered by one or more servers, users and operators. When the notes section of the database is accessed, the database may automatically activate a list of standardized pop-up notes for a server, for example, to check off the items that apply to a patron, and store that information.

The system can also be used to determine if a particular section of a venue is becoming too unruly or if alcoholic dispensation in a particular section is approaching a tolerance limit. If a section is deemed too unruly or if a limit is reached, alcohol distribution and sales to that section can be curtailed or ceased altogether.

Further, the system may be linked to other systems, such as liquor service in a sports stadium, so that sales of alcoholic beverages automatically terminate at pre-programmed times whether such sales occur at kiosks or in connection with servers who implement orders from patrons. For example, the system may be programmed to forbid the sale of alcohol before noon on a Sunday or after a certain period of time has elapsed (i.e., after the 6^{th} inning of a baseball game). The inventive system can also be used by other venues where alcohol is not sold past a certain time, such as bars which have a “last call.”

### BRIEF DESCRIPTION OF THE DRAWINGS

The features and advantages of the tracking system will become further understood with reference to the following description, appended claims and accompanying drawings, in which:

FIG. 1 is a flow chart of a preferred embodiment of the present invention;

FIG. 2 shows a block diagram of a system for implementing the invention of FIG. 1; and

FIG. 3 shows a flow chart for another aspect of the invention.

### DETAILED DESCRIPTION OF THE INVENTION

The present invention pertains to a system that can monitor, control, track, tally, record or otherwise restrict the purchase, sale and distribution of alcoholic products within specific confines and/or time frames at a specific venue. An ongoing tally or count of sold or distributed alcoholic beverages preferably occurs at a point of purchase, but it should be understood that the information relating to the tally may be kept off site as well, at a location that is on site, but different than the point of purchase, or both. Purchases can be made using a variety of vending locations discussed herein, including standard full service counters with one or more servers, kiosks with a more limited number of products and less servers than a counter and, roaming vendors with hand-held devices, and credit/debit/cash point-of-sale devices. All such devices can be integrated with one another, giving them the capability to communicate with each other or to operate individually or to communicate with a centralized processor or group of processors. It should also be further understood that a system (comprising, for example, multiple kiosks, remote processors and counters with point-of-sale devices) at a particular venue may also be linked to one or more other systems that are located elsewhere, thereby forming a larger and more comprehensive system that capable of performing its intended functions over a larger area and multiple venues.

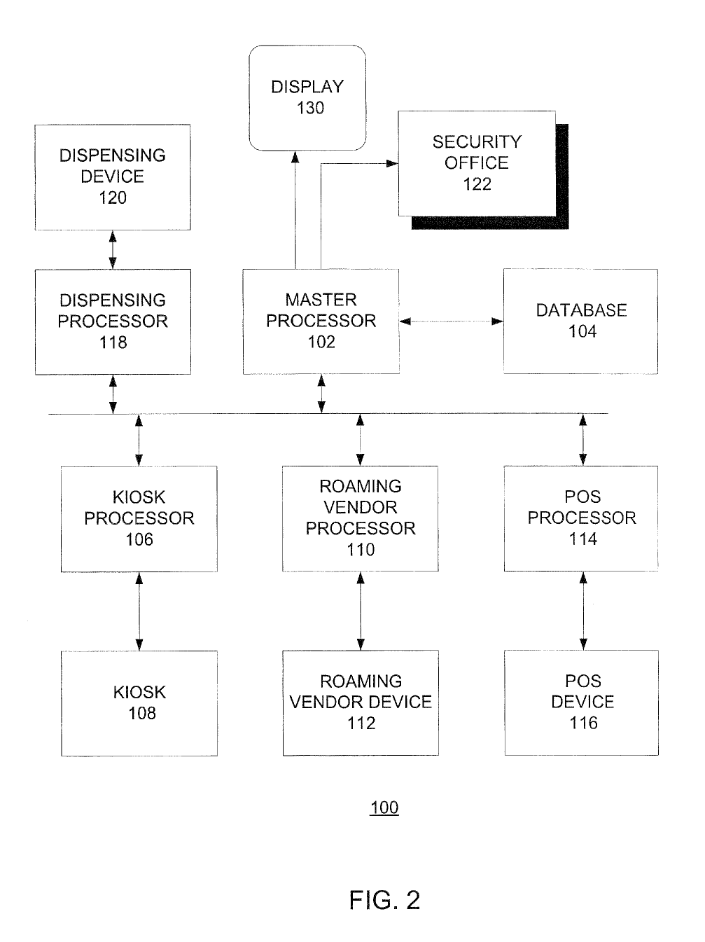

FIG. 2 shows a block diagram of a system 100 constructed in accordance with this invention. The system 100 includes a master processor 102. As discussed above, processor 102 can be on site of the event, or can be at a remote location. Moreover, the processor 102 may provide other functions as well that are not related to the alcohol distribution discussed herein. The processor 102 is coupled to a database 104 that is used to store patrons IDs, purchase histories (including alcoholic and non-alcoholic products), the rules for alcohol distribution and other associated data. The master processor 102 also exchanges data with a kiosk processor 106, a roaming processor 110, and/or a POS processor 114.

In one embodiment, the system includes a separate dispensing device 120 associated with a dispensing data processor 118. The device 120 can dispense products to patrons after the patrons have been authorized to purchase a product and have paid. The dispensing device 120 may require each patron to provide an ID before receiving a product to insure that the patron is the same person as the one who has been authorized previously.

The system may have access to the DMV records with driver's license information or any other governmental database with identifying information to check for underage patrons, to prevent minors from buying alcohol or to prevent purchases of alcohol from those convicted of DWI or DUI. In a further embodiment of the present invention aimed to prevent underage drinking (as well as attempts to purchase alcohol with a fake ID or someone else's ID), the system may employ a camera that, using face recognition, compares the patron's image with the driver's license. The system can also print receipts.

The system may employ one or more networks to connect its devices in order to update and retrieve patrons' information, process credit card payments and/or to have access to DMV records or law enforcement agency records. The devices connected to the networks may be a combination of point of sale locations, kiosks, and/or portable remote devices such as mobile phones. The networks may be landline (phone, coaxial cable, DSL, fiber optic cable) or the networks may utilize wireless communications (satellite, WIFI, cell phone, cellular digital packet network, or any other suitable wireless connection).

Information regarding sales, especially sales of alcoholic beverages may be shared with other entities, such as a security office 122.

The processors monitor and provide controls and data information to the respective vending locations Of course processors 106, 110, 114, 118 can be implemented as a single device or can be integrated into the master processor 102, however, they are presented here as separate units for the sake of clarity.

In addition the master processor 102 is associated with a display 130 on which various supervisory personnel can monitor the operation of the system, the number of drinks sold, the number of patrons rejected, etc.

Kiosks

At each kiosk 108, the patron can purchase alcohol either with cash or with a Credit/Debit card. Each kiosk can provide both types of transactions, or alternatively different kiosks are provided for cash and for credit/debit transactions. The kiosks use touch screens and voice assist to guide the patron during the process.

The system can further be implemented without the need for a server at every location. A patron can go to a kiosk 108 and the kiosk 108 may include in one embodiment an automated dispensing device that can process automatically all the information required for later dispensation of an alcoholic beverage, including a scan of the patron's ID and an appropriate verification thereof. Minimizing the server input required to serve an individual patron allows one server to serve more patrons, which is desirable at any venue, particularly a venue with a high patron throughput. Preferably, the system may request that a dispensing vendor ask the patron to provide his ID again when picking up the alcoholic drink to ensure that the authorized patron is the person actually picking it up at the kiosk.

As discussed above, as part of the transaction, the master processor 102 determines whether a patron is authorized to have an alcoholic beverage, based on his age, previous and current history and/or other rules, such as a prior record of unruly behavior. The information is then relayed back to the processors 106, 110, 114 and could include a warning indicating that the maximum amount to be served has been reached (in which case the patron is refused) or is approaching the maximum amount to be served or purchased which is delivered to the patron. In an alternate embodiment, the message includes a warning to the vendor or some other personnel to check the patron for sobriety (using, e.g., a breath analyzer), or a warning to complete a visual check for sobriety or drunkenness. The vendor can then choose to dispense the alcohol or refuse the alcohol purchase. A printed receipt is generated in duplicate, for the patron and for the venue's records, to confirm the purchase or in the event of denial of purchase.

As mentioned above, at the point of pick up, preferably the person picking up the alcoholic beverages must pass a verification process using his or her ID. Alternatively, if automated dispensing is used, then the person picking up an order provides his ID to the dispensing device 120. The dispensing device 120 checks through its processor 118 whether an alcoholic drink can be dispensed, and then, if allowed, the device dispenses the beverage.

The kiosks may be adapted to accommodate roaming vendors as well in a section of a venue (i.e. stadium stands or the like).

Roaming Vendors

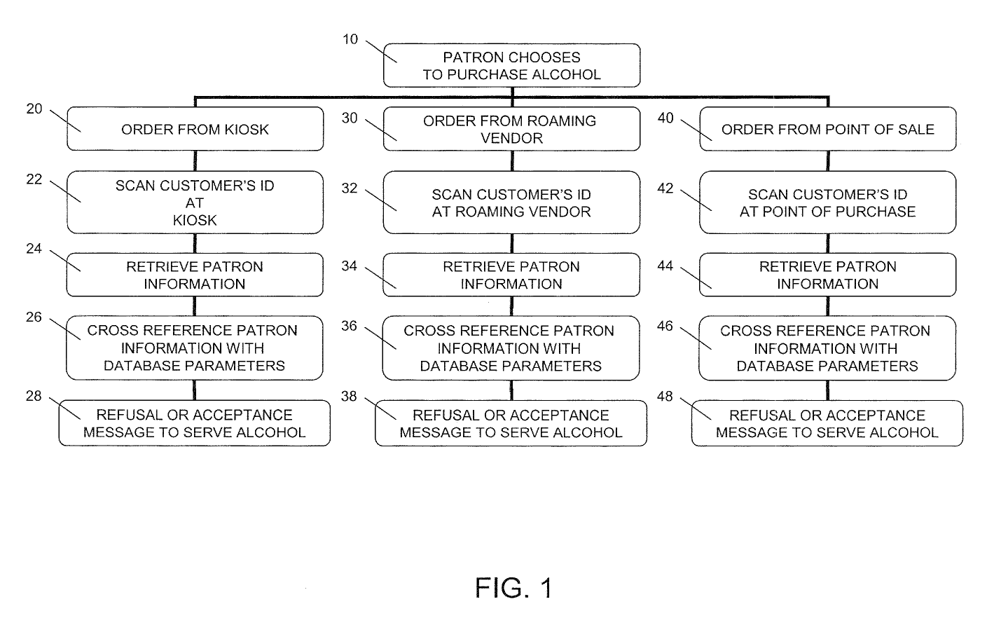

Referring again to FIG. 2, another preferred embodiment of the present invention provides the purchase of alcohol from a roaming Vendor through a remote vending device 112. The vendor can accept payment via cash, credit or debit. This roaming, remote payment process is executed by the vendor who walks around the venue, and whose purpose is to sell alcohol. A portable device 112 including reader (not shown) is carried or is disposed nearby the vendor. The vendor scans a patron ID and the transaction proceeds as discussed below in FIG. 1. The portable device includes a LCD or other similar display in which information (including messages regarding a particular patron are provided to the vendor. If the device 112 is portable, communication with its processor 110 can be accomplished via standard wireless communication means.

The tally for each transaction and the patron-specific ID and other information is stored in the database 104, beginning at the first purchase, where the term “first purchase” in this context means the first purchase within the confines of a particular venue, on a given system or a particular event.

Preferably, the tally and the information is preserved in the database 104 until the end of the event or until the patron exits from the facility or for an extended period of time, as may be desired for later review and analysis. Such later review could include developing a database of patrons which can be used to track unruly behavior or patterns of alcohol purchasing, to better serve that patron. Once the set time passes, the database records the number of alcoholic beverages consumed during the event. Optionally this data can be transmitted to external data collection sites. The tracking system can also generate various reports using the recorded information. One report can be generated to each roaming vendor. The system has the ability to retain this information in case it is needed in a later dispute.

The kiosks can be set up so that they can be operated by a server, a vendor or can be used for self-service, even away from a salesperson or a cash register, provided that the kiosks are configured to accept payment and dispense the alcoholic beverages.

Point of Sale Purchase

A patron may also make a purchase at a location or housing including, for example a full service counter for selling many different products, among them alcoholic beverages, with one or more servers and at least one point of sale (POS) device 116 such as a register. The POS device 116 exchanges data with master processor (and optionally the other locations) through POS processor 104.

The operation of the subject system is now described in conjunction with FIGS. 1 and 2. Initially, a fan or patron chooses to order alcohol (step 10) at a venue. The order can be placed at one of several different locations or dispensing means such as from (a) a kiosk 108, (b) a roaming vendor device 112, or (c) counter or other Point of Sale location or device such as, e.g. a register, 116 (steps 20, 30, or 40). At each of these locations, payment can be accepted using cash, credit or debit card, or a combination of any of these known payment vehicles.

Next, the patron is requested to present a suitable ID. The presented ID is then scanned (steps 22, 32 or 42). Using the scanned data, a patron's information, which may include basic information and history of past alcohol purchase is retrieved from database 104 by either master processor 102 or one of the processors 106, 110, 114 together with the applicable rule(s) or parameters for limiting the sale of alcoholic beverages. (steps 24, 34, 44). The information is then cross-referenced or compared by the respective processor to parameters or rules for alcohol distribution (steps 26, 36, 46). In response, a refusal or acceptance message to serve alcohol is provided (steps 28, 38, 48) to the respective dispensing device (108, 112, 116) for further respective action by the processor (if any). For example, if the patron has exceeded a predetermined threshold, he may receive a printed note informing of such. A copy of that note is saved and/or printed for the server as well. This decision may be made strictly on the number of drinks or the number of ounces of alcohol consumed by the patron. More sophisticated determinations may be made using the weight of the patron, his/her gender, his/her past history, etc. and all this information may be placed on the note. More complex warnings may also be generated. For example, a patron may be served with a warning that he or she is approaching the limit set by the venue, or that this is the last drink that he can get for the next X hours, etc.

In an alternate embodiment, the server, or other personnel (e.g., security personnel employed by the venue) may check a patron for sobriety, for example by giving the patron a physical or mental test. The results of the tests are recorded, printed on the note and stored as well.

If the order is accepted, the patron is served.

Every time a patron requests alcohol, the system retrieves the patron information including historic data such as previously purchased alcoholic beverage(s). The required information can be retrieved from the database by using the ID provided by the patron.

As discussed above, an important feature of the invention is that a patron has to present an ID for each order namely, at a point of purchase. The patron information may be obtained from a magnetic stripe, barcode, RFID, digital image, on an appropriate document or may be obtained by scanning in text from a document and converting text. The ID information may include the patron's name, drivers' license number, ID number, birth date, height, photograph and/or biometric data or a combination of the foregoing items. The patron may also be queried with respect to alcohol preferences or sensitivities, such as allergies. Once a transaction with a patron is completed, the corresponding information is updated in database 104 so that the information can be used in the future to maintain data on a patron's alcohol choices (to better serve the patron) or to track unruly patrons (so that the venue can be aware of the patron's nature and choose to limit the dispensation of alcohol and be ready if security is needed). The master processor 102 tallies all subsequent alcohol purchases by a patron by calculating the number of the alcoholic beverages purchased by the patron, preferably within a predefined period of time, and stores the results in the same or different database that stores patron's identifying information. The tally is held in the database 104 (and or other memory), beginning at the first purchase, where the term “first purchase” in this context means the first purchase within the confines of a particular venue, on a given system, at a particular event, or a particular date. Preferably, the tally is kept until the end of the event, until the patron exits from the facility or perhaps for an extended period of time, as may be desired for later review and analysis. The time period and threshold levels used to control alcohol purchases is typically defined by the host venue, by using a number of parameters, which may include opening and closing hours of operation of the venue, time from first dispensation of alcohol and last, or time of opening until alcohol purchases are terminated. More sophisticated rules for determining these thresholds may also be used, including the age of the patron, his/her prior history, criminal records, etc. It should be understood that the rules for setting these thresholds may be set by a person or entity other than the host venue, and that such time period may be a universal standard applied to multiple venues. To be effective, one large venue, such as an arena or stadium, may require its restaurants and other points of alcohol dispensation to use the tracking system so that the time period is uniformly defined for any particular patron. Venues in a city or any other geographically-defined locale may likewise find it beneficial to use the tracking system in the same or similar manner.

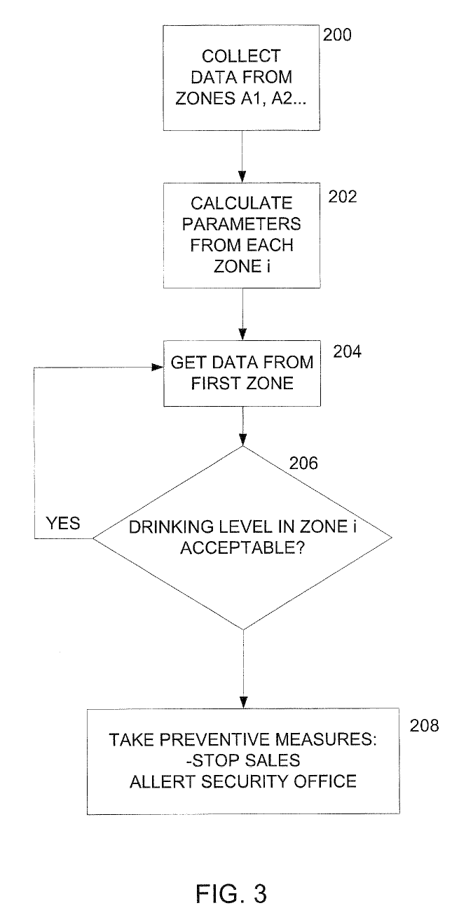

In an alternate embodiment, the master processor 102 tallies not only the number of drinks (and/or the amount of alcohol) consumed by a patron on an individual basis, but also accumulates this information for a number of patrons, based on designated zones within the venue. For example, the individual patron's purchase data is collected and tallied to obtain a cumulative number within sections, gates, floors, or rows of the venue. This total amount per zone, or alternatively, the alcohol consumption per capita can be shown in display 130 in any suitable format, such as a table consisting of one column identifying the various zones of the venue and another column indicating the amount of alcohol consumption in each zone. Alternatively a map is generated on the display 130 of the venue with various zones color coded to show alcohol consumption. For example, the various zones may be green, yellow and red to indicate cold, warm and hot zones, respectively, with green indicating low alcohol consumption, yellow indicating moderate alcohol consumption and red indicating high alcohol consumption. The master processor 102 also calculates the total alcohol consumption for the whole venue. The end user or viewer (concession management, security, and operations management of the venue) is then able to view, monitor and zone the purchases according to the gates, sections, and rows, versus total purchases of alcohol. The venue management can also take appropriate measures such as restrict, limit or shut down alcohol dispensing within a particular area or zone. Alternatively, or in addition, a message is sent to the security office to request the assignment of additional security personnel to particular zone area. This mode of operation is shown in FIG. 3. In step 200, alcohol consumption is collected and calculated from various zones designated as A1, A2, A3 and so on. In step 202 various crucial parameters are calculated, such as total alcohol consumption per zone in the last x hours, or since the beginning of the event, the alcohol consumption per patron, the alcohol consumption per attendee (including both patrons and non-patrons) and so on. In steps 204 and 206 data from the first zone is retrieved and analyzed to determine if the alcohol consumption for that level is acceptable. The process is repeated for every zone of the venue. If the alcohol consumption level for any one zone is too high, preventive measures are taken in step 208 by reducing or stopping the sale of alcohol, alerting the security office 122 and requesting additional guards, etc. Additionally, the same restrictions may be applied to the whole venue.

The monitoring and tallying of purchases may be integrated with the architectural layout of the facility (the venue being: an arena, stadium, bar, restaurant, dance club, or gentlemen's club). The end user or viewer can set color graphics or define highlighted areas to determine or indicate the number of purchases from a given area, section, gates, or rows of the venue.

To summarize, the alcohol consumption in a public venue can be curtailed or controlled both on an individual level, and in the whole venue. On an individual level, in one embodiment, the alcohol consumption is completely cut-off when the individual reaches a predetermined threshold based on the number of drinks consumed, the volume of alcohol consumed, etc. In an alternate embodiment, two or more thresholds are set for individuals. Alcohol consumption may also be controlled or restricted in various zones based on a number of different parameters, and even on universal basis affecting all the zones in a particular venue. Moreover, the controlling of alcohol consumption can be implemented in a number of different ways, using a single step, or multiple steps. In one embodiment of the invention, when a threshold for the respective area (be that an individual, zone or universal), a control signal is generated by the software indicating that no more alcohol is to be sold. Moreover, the control signal may also be generated when a particular time-sensitive event occurs that need not be directly related to alcohol consumption. For example, the signal may be generated at baseball game when the 8^{th} inning starts, at a football game at the beginning of the fourth quarter, at a soccer game, after 75 minutes of play, and so on. The control signal can be generated automatically by the software or a switch can be actuated manually by a security or management personnel.

In another embodiment, two or more thresholds may be used. When the first threshold is reached, a warning may be generated to the individual (and, if applicable, the vendor) or others indicating that a critical period has been reached and the sale of alcohol is going to be cut off soon. Moreover, the warning may be issued to a vendor if he has sold a beverage to a customer after the signal to stop sales has been received. Finally, an electronic or electromechanical valve is provided which, in response to the control signal, is activated to actually open or close a pipe that is used for the delivery of alcoholic beverages. The control signal can be generated at a remote location.

As mentioned above, the present system can also be used to monitor the number of drinks sold by vendors to insure that the customers are not short changed. In one embodiment, this function is performed by comparing the number of drinks sold with the number of cups used. In another embodiment, a flow meter is used to measure the amount of alcohol is sold by volume.

Although the invention is described in terms of particular embodiments, it is to be understood that the embodiments are merely illustrative of an application of the principles of the invention. Numerous modifications may be made and other arrangements may be devised without departing from the spirit and scope of the invention. For example, the tracking system is just as applicable to venue events where alcoholic beverages are distributed without requiring payment from the patrons rather than sold (i.e., an “open bar” reception where the system can be used to track and restrict alcohol consumption to meet the goals of the present invention).

I claim:

1. A system for monitoring alcohol consumption of patrons in a venue comprising:
an ID reader that receives an ID that uniquely identifies the patron and generates patron specific data based on the ID;
a data processor receiving said patron data and generating in response an output indicative of whether the patron is eligible to receive an alcoholic drink based on said patron data and a predetermined criteria; and
a display presenting information based on said output.

2. The system of claim 1 wherein said venue includes several sectors, alcoholic beverages being dispensed for patrons of each sector and said data processor further calculates a tally totaling alcoholic beverage dispensation at one of said sectors.

3. The system of claim 1 wherein alcoholic drinks are dispensed within said venue based on said output and said data processor tallies total alcoholic drink dispensation at the venue.

4. The system of claim 1 wherein said predetermined criteria includes a limit, said data processor performing a comparison between a quantity of alcohol received by the patron and said limit to generate said patron data.

5. The system of claim 1 wherein said ID receiver receives the ID each time the patron orders an alcoholic drink, said processor calculates the amount of alcohol consumed by the patron prior to a current order and said information includes one of said amount of alcohol and the number of drinks previously ordered.

6. The system of claim 5 wherein said information includes a warning message that the tally is approaching the limit.

7. The system of claim 1 wherein said ID receiver is adapted to receive one of a document and a biometric parameter from the patron.

8. The system of claim 1 wherein said ID receiver is adapted to receive one of a credit card, a debit card, a driver's license and a passport, said ID receiver scanning text there from to generate said patron specific data.

9. The system of claim 1 further comprising a memory storing a database, said memory communicating with said data processor and storing said patron specific data.

10. The system of claim 1 wherein said data processor receives a user input, said predetermined criteria being related to said user input.

11. The system of claim 1 wherein said data processor receives an input from an external source, said input being used to determine said predetermined criteria.

12. The system of claim 1 further comprising a plurality of stations for receiving patron orders, each station including a respective ID receiver.

13. The system of claim 12 wherein said plurality of stations include at least one of a portable device that can be operated by a roaming vendor, a kiosk including fixed drink dispenser and a fixed housing including an POS device.

14. The system of claim 13 wherein said kiosk includes an automatic drink dispensing for a dispensing drink to an eligible patron.

15. A method of tracking alcohol consumption at a venue with patrons receiving alcoholic drinks comprising the steps of:
calculating a tally of alcoholic beverage consumption for the patron at the venue;
receiving and scanning patron IDs to generate patron specific data unique to a patron desiring an alcoholic drink, comparing the tally with a predetermined limit; and
generating a message to a server based on said comparison to indicate the eligibility of the patron to receive said alcoholic drink.

16. The method of claim 15 wherein said venue includes at least one station with an ID receiver receiving said ID and a central processor communicating with said one station via a network further comprising the step of transmitting the patron specific data over said network so as to enable tracking and controlling alcoholic beverage dispensation remotely.

17. The method of claim 15 further comprising the step of receiving information from external sources regarding a past history of the patron.

18. The method of claim 15 further comprising the step of receiving information from the patron regarding the patron's preferences for one or more types of alcohol.

19. The method of claim 15 further comprising the step of receiving information from the patron regarding the patron's allergies to alcohol.

20. The method of claim 15 wherein said venue includes several zones and a processor calculating the amount of alcohol consumed by respective patrons in each zone, further comprising generating information from said processor indicative of said amount of alcohol.

21. A method of tracking and controlling alcohol dispensations comprising the steps of:
collecting patron information in response to a request for an alcoholic drink by a patron;
storing the patron information in a database beginning with a patron's first dispensed beverage at a venue;
calculating a tally of alcoholic beverage consumption for the patron at the venue and storing the tally in the database;
recalling and comparing the tally with a limit set by the venue; and
communicating a message to a server indicating if the patron is eligible to receive said drink based on said comparison.

22. The method of claim 21 wherein said server receives a message prohibiting said drink based on said comparison.

23. The method of claim 21 wherein the patron information is collected by scanning patron IDs.

24. The method of claim 21 wherein the patron information is collected by using biometric ID scanning of the patron.

25. The method of claim 21 further comprising dispensing said drink to the patron if said comparison indicates that the patron is eligible.
